(19) United States
(12) Patent Application Publication
(10) Pub. No.: US 2009/0023424 A1
(43) Pub. Date: Jan. 22, 2009

(54) ACQUIRING IDENTITY PARAMETER

(75) Inventors: Paul Maxwell Martin, Hampshire (GB); Riki Benjamin Dolby, Hampshire (GB)

Correspondence Address: NIXON PEABODY, LLP, 401 9TH STREET, NW, SUITE 900, WASHINGTON, DC, 20004-2128, US

(73) Assignee: M.M.I. RESEARCH LIMITED, Hartley Wintney, Hampshire (GB)

(21) Appl. No.: 12/162,548

(22) PCT Filed: Jan. 30, 2007
(86) PCT No.: PCT/GB07/00309

§ 371 Date: Sep. 23, 2008

(30) Foreign Application Priority Data
Jan. 31, 2006 (GB) 0601954.1

(51) Int. Cl. H04L 9/32; H04M 1/66

(52) U.S. Cl. 455/411

(57) ABSTRACT

A method of acquiring an identity parameter of a device registered with a network. The device is configured to respond to a set of integrity protected requests from the network only after the device has authenticated the network. The device is also configured to respond to a non-integrity protected identity request from the network without requiring authentication of the network. The method comprises transmitting a false cell broadcast which is not under the control of the network, the false cell broadcast including the non-integrity protected identity request; and receiving the identity parameter from the device in response to the identity request.

The present invention is concerned with a method and associated apparatus for acquiring an identity parameter of one or more mobile devices.

An IMSI Catcher is described in Hannes Federrath, Security in Mobile Communications: Protection in GSM networks, mobility management and multilateral security—Braunschweig; Wiesbaden: Vieweg, 1999, ISBN 3-528-05695-9. The IMSI Catcher behaves like a BTS and like an MS in relation to the “genuine” BTS of the network carrier. The IMSI Catcher transmits a signal on the BCH, which must be received more strongly by the MSs than the signal of the genuine BTS. The MSs continuously select the BTS that can be optimally reached and consequently they answer to the IMSI Catcher.

A method for identifying the user of a mobile telephone and for listening in to outgoing calls is described in EP-A-1051053. A Virtual Base Station (VBTS) obtains a Broadcast Allocation (BA) list of base stations, selects a base station from the BA list, and emulates the base station in order to acquire identity parameters (IMSI, IMEI) from the mobile telephone. EP-A-1051053 is concerned with obtaining the IMSI and IMEI of a single target device, in order to intercept the calls of the user.

The present invention provides a method of acquiring an identity parameter of a device registered with a network, the device being configured to respond to a set of integrity protected requests from the network only after the device has authenticated the network, the device also being configured to respond to a non-integrity protected identity request from the network without requiring authentication of the network, the method comprising transmitting a false cell broadcast which is not under the control of the network, the false cell broadcast including the non-integrity protected identity request; and receiving the identity parameter from the device in response to the identity request.

The invention is particularly suited for acquiring the parameter of a device registered with a Third Generation (3G) network which typically has a high level of authentication required.

An embodiment of the present invention will now be described with reference to the accompanying drawings, in which:

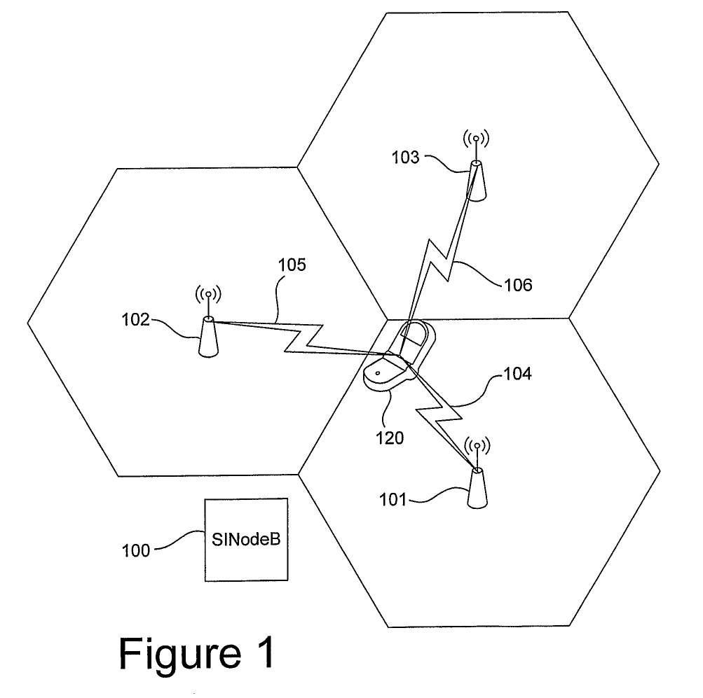

FIG. 1 is a schematic diagram showing a 3G network including a User Equipment device (UE), and a Separately Introduced NodeB (SINodeB); and

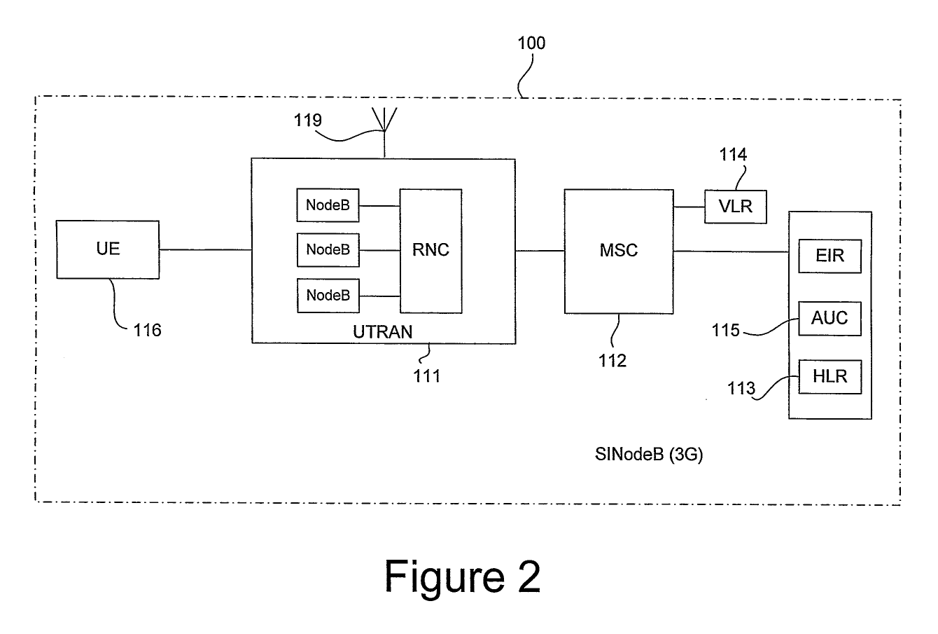

FIG. 2 shows the SINodeB in further detail.

FIG. 1 shows a 3G network comprising three NodeBs 101-103 broadcasting to three cells by downlink transmissions 104-106 each having a unique downlink scrambling code. On moving into the vicinity of the three NodeBs, a User Equipment device (UE) 120 evaluates on which NodeB to camp.

The UE 120 is required to constantly re-evaluate the signals from cells around it. It does this to ensure that during a connection (data or voice) it is always communicating with the best (most appropriate) NodeB. However a 3G UE will spend most of its time when not transmitting voice or data traffic in an idle state. In this idle state the UE will monitor the strength of the serving NodeB and other neighbour NodeBs, and if the criteria specified by the network are met then it will perform a cell reselection converting one of the previous neighbour NodeBs into the new serving NodeB. If this new serving NodeB is in a different location or routing area then the UE must perform a location or routing area update procedure to inform the network of its new location. This is done so that the network will always have an idea of where the UE is in the network, so that in the event of an incoming call request to the UE the network can use the minimum amount of resources to request the UE to establish a signaling connection.

Each NodeB transmits broadcasted information that serves two main purposes. First, some of this information is transmitted using well know codes and data patterns that allow the UE to recognise that the Radio Frequency (RF) signal being received is actually a UMTS cell and also allows the UE to perform power measurements on the received signal. Second, descriptive information about the cell is broadcast. This system information is transmitted in the form of System Information Blocks (SIBS) which describe many parameters of the NodeB and provide enough information for the UE to identify the mobile network that the NodeB belongs to, and also to establish a signaling connection if it needs to.

FIG. 2 shows a Separately Introduced NodeB (SINodeB) 100. The SINodeB 100 is configured to acquire an identity parameter from a UE registered with the 3G network of FIG. 1. This is achieved by emulating a NodeB using a method specially adapted to the UMTS protocol, as described in further detail below.

The SINodeB 100 is typically a mobile device, which may be housed in a vehicle. In use, the SINodeB 100 is moved to an area, and operated to acquire identity parameters from one or more User Equipment devices (UEs) registered with the 3G network in that area. Alternatively the SINodeB 100 may be permanently located in an area of interest. In both cases, the SINodeB 100 effectively transmits a false cell broadcast which is not under the control of the 3G network providing coverage to that area.

In order to persuade the UE to move over to the SINodeB 100, certain criteria must be met. Primarily the transmission must be received at the UE with a higher signal strength. Even once the UE has made the decision that the SINodeB 100 is preferential it would normally be considered necessary to pass the UMTS security procedures in order to be able to gather any useful information or perform any useful tasks.

It is not necessary to exactly emulate all the configuration of an existing NodeB for it to be a suitable candidate for a UE to connect to. This makes the task of configuring the SINodeB 100 much simpler. The reason for this is that the broadcasted system information defines the configuration of the cell that is transmitting that data, and cells within the same network will have different configurations, so the UE always looks at the data from the current cell to determine the necessary information.

The key parameters in the false cell broadcast that need to be considered for changing are as follows:
Cell Frequency
Primary Scrambling code
Mobile Country Code (MCC) [—which country this cell is in]
Mobile Network Code (MNC) [—which network this cell belongs to]
Location area code (LAC)
Routing area code (RAC)
Cell power
SIB value tags [—Value tags are use by the UE to detect if SIB information has changed between reads of the SIBs]
Contents of SIB18 and SIB11 for serving cell [—SIB 11 contains measurement control information to be use by the UE in idle mode/SIB 18 contains PLMN ids of neighbour cells to be considered in idle and connected mode]

The MCC and MNC must be the same as the serving cell for the UE to consider the SINodeB to be in the same network.

The Cell Frequency must be the same as the serving cell to make the process as easy as possible—interfrequency reselections have more complex criteria and processes.

There are several options for configuring the other parameters transmitted by the SINodeB:

1) Same LAC/RAC and Primary Scrambling codes different SIB value tags—This completely mimics the serving cell, and allows the SINodeB to actively grab the UE.
2) Different LAC/RAC and Primary Scrambling code—where Scrambling code is present in the SIB11 of the serving cell. This is mimicking a neighbour NodeB that the serving NodeB has been instructing the UE to perform measurements on—thus ensuring that the UE is trying to look for the SINodeB. This causes a UE to perform a cell reselection to the SINodeB if the SINodeB transmission is of sufficiently higher power than the serving NodeB. The amount by which the SINodeB needs to be a stronger signal is defined in SIB3 of the serving NodeB.
3) Different LAC/RAC and Scrambling code—no reference in SIBS of the serving NodeB.

Once a suitably strong and configured cell is being transmitted, the UEs in the target area will perform a cell reselection to the SINodeB and establish an RRC connection for the purpose of performing a location updating procedure. The location update is required because the LAC of the SINodeB is different from the old serving SINodeB. Once the RC connection is established the SINodeB has the opportunity to perform other signaling procedures as desired.

The UMTS protocol is designed to enhance the security and identity protection features in GSM. To this end, authentication and integrity mechanisms are used in addition to the temporary identities found in GSM. These temporary identities avoid the frequent transmission of the identity of the IMSI and the IMEI, because once the network has assigned the phone a temporary identity then it maintains a mapping from that new identity to the IMSI.

Mechanisms exist to allow the network to interrogate a phone for its IMSI and IMEI and these are used for the first connection of a phone to the network or when an error has occurred and the network needs to re-establish the correct mapping between a temporary identity (such as a TMSI) and its associated real identity (such as an IMSI). In normal network operation almost all signaling between the UE and the network must be performed after the authentication procedure has been completed successfully and integrity has been enabled on the signaling connection. This makes the falsification or modification of signaling by a third party effectively impossible.

Unless a NodeB is provided with a mechanism to successfully pass the authentication and integrity procedures then the UMTS protocols are designed that almost no useful communication can be achieved with the UE. However there are “gaps” in the UMTS protocols that allow the IMSI, IMEI and TMSI to be retrieved from the UE by the SINodeB 100 without requiring these security mechanisms.

These “gaps” are described in 3GPP TS 33.102 version 3.13.0 Release 1999, and in 3GPP TS 24.008 version 3.19.0 Release 1999. The relevant portions of these protocols will now be described.

### 3GPP TS 33.102 Version 3.13.0 Release 1999

This protocol specifies in Section 6.5 that all signaling messages except the following shall be integrity protected:

### HANDOVER TO UTRAN COMPLETE

### PAGING TYPE 1

### PUSCH CAPACITY REQUEST

### PHYSICAL SHARED CHANNEL ALLOCATION

### RRC CONNECTION REQUEST

### RRC CONNECTION SETUP

### RRC CONNECTION SETUP COMPLETE

### RRC CONNECTION REJECT

RRC CONNECTION RELEASE (CCCH only)

### SYSTEM INFORMATION (BROADCAST INFORMATION)

### SYSTEM INFORMATION CHANGE INDICATION

Thus these messages cannot be integrity protected under any circumstances.

### 3GPP TS 24.008 Version 3.19.0 Release 1999

This protocol specifies a list of messages which the UE can respond to, in certain circumstances, without first having integrity protected the network. Specifically, the protocol states the following:

Except the messages listed below, no layer 3 signalling messages shall be processed by the receiving MM and GMM entities or forwarded to the CM entities, unless the security mode control procedure is activated for that domain.
MM messages:
AUTHENTICATION REQUEST
AUTHENTICATION REJECT
IDENTITY REQUEST
LOCATION UPDATING ACCEPT (at periodic location update with no change of location area or temporary identity)
LOCATION UPDATING REJECT
CM SERVICE ACCEPT, if the following two conditions apply:
no other MM connection is established; and
the CM SERVICE ACCEPT is the response to a CM SERVICE REQUEST with CM SERVICE
TYPE IE set to ‘emergency call establishment’
CM SERVICE REJECT
ABORT
GMM messages:
AUTHENTICATION & CIPHERING REQUEST
AUTHENTICATION & CIPHERING REJECT
IDENTITY REQUEST
ATTACH REJECT
ROUTING AREA UPDATE ACCEPT (at periodic routing area update with no change of routing area or temporary identity)
ROUTING AREA UPDATE REJECT
SERVICE REJECT
DETACH ACCEPT (for non power-off)
   CC messages:
all CC messages, if the following two conditions apply:
no other MM connection is established; and
the MM entity in the MS has received a CM SERVICE ACCEPT message with no ciphering or
integrity protection applied as response to a CM SERVICE REQUEST message, with CM SERVICE
TYPE set to ‘Emergency call establishment’ sent to the network.

Therefore an RRC Connection can be set up without requiring integrity protection, since the RRC connection messages are listed as not requiring integrity protection in 3GPP TS 33.102 version 3.13.0 Release 1999. After an RRC Connection has been established between the SINodeB and the UE, for the purpose of a location update procedure a series of MM Identity Requests are sent by the SINodeB 100 to retrieve the UE identification information. Again, the UE responds to these MM Identity Requests without requiring integrity protection because MM Identity Request is specified in the list given above in 3GPP TS 24.008 version 3.19.0 Release 1999.

Specifically, the series of messages between the UE and the SINodeB is as follows:

### UE <-> SINodeB

### -> RRC Connection Request

### <- RRC Connection Setup

### -> RRC Connection Setup Complete

### -> MM Location Update Request

### <- MM Identity Request (Requesting IMSI)

### -> MM Identity Response (IMSI)

### <- MM Identity Request (Requesting IMEI)

### -> MM Identity Response (IMEI)

### <- MM Identity Request (Requesting IMEISV)

### -> MM Identity Response (IMEISV)

### <- MM Identity Request (Requesting TMSI)

### -> MM Identity Response (TMSI)

When the UE sends the MM Location Update Request, it also starts an LAC update timer. The SINodeB ignores this request. If the UE does not receive a valid response to the MM Location Update Request within a predetermined time, then the UE resends the MM Location Update Request. This process is repeated a few times and then the UE aborts the connection.

Thus by sending the series of three MMI Identity Requests straight after the RRC Connection is established, and before the UE aborts the connection, the SINodeB can receive the MM Identity Response messages from the UE without requiring integrity protection.

Once the identity information has been collected, the SINodeB rejects the location update request thus preventing the UE from repeatedly trying to camp on to the SINodeB.

1. A method of acquiring an identity parameter of a device registered with a network, the device being configured to respond to a set of integrity protected requests from the network only after the device has authenticated the network, the device also being configured to respond to a non-integrity protected identity request from the network without requiring authentication of the network, the method comprising transmitting a false cell broadcast which is not under the control of the network, the false cell broadcast including the non-integrity protected identity request; and receiving the identity parameter from the device in response to the identity request.

2. A method according to claim 1, wherein the identity request is an identity request specified in a 3G network protocol.

3. A method according to claim 2, wherein the identity request is an identity request specified in a UMTS network protocol.

4. A method according to claim 1, wherein the identity request is an MM identity request.

5. A method according to claim 1, wherein the device has been assigned with a temporary identity parameter by a network with which the device is registered, and wherein the non-integrity protected identity request is intended for use when the network loses a mapping between the temporary identity parameter and a permanent identity parameter.

6. A method according to claim 1, wherein the non-integrity protected identity request is intended for use when the device roams from an old network to a new network.

7. A method according to claim 1, further comprising setting up a non-integrity protected connection with the mobile device.

8. A method according to claim 7, wherein the connection is an RRC connection.

9. A method according to claim 1, further comprising moving a separately introduced device to an area; and operating the device to perform the method on a device registered with the network in that area.

10. A computer program product which, when run on one or more computers, causes the computer(s) to perform a method according to claim 1.

11. Apparatus configured to perform a method according to claim 1.
